(19) United States
(12) Patent Application Publication
(10) Pub. No.: US 2021/0149723 A1
(43) Pub. Date: May 20, 2021

(54) METHOD AND APPARATUS FOR MICROSERVICE ARCHITECTURE RECONFIGURATION

(71) Applicant: Electronics and Telecommunications Research Institute, Daejeon (KR)

(72) Inventors: Il Soon JANG, Daejeon (KR); Dae Ho KIM, Sejong-si (KR); Chan Won PARK, Daejeon (KR); Won Kyu CHOI, Daejeon (KR)

(73) Assignee: Electronics and Telecommunications Research Institute, Daejeon (KR)

(21) Appl. No.: 17/027,092

(22) Filed: Sep. 21, 2020

(30) Foreign Application Priority Data
Nov. 18, 2019 (KR) 10-2019-0147957

(51) Int. Cl. G06F 9/48

(52) U.S. Cl. CPC G06F 9/4881; G16Y 10/75; G06F 9/485

(57) ABSTRACT

A method for reconfiguring a microservice architecture that performs a mission by combining a plurality of tasks connected through signals may comprise decomposing a combination of tasks associated with a mission as the mission is changed; recombining tasks by varying the combination of the tasks according to connection management information; and performing a changed mission based on the recombined tasks.

### CROSS-REFERENCE TO RELATED APPLICATIONS

This application claims priority to Korean Patent Application No. 10-2019-0147957 filed on Nov. 18, 2019 with the Korean Intellectual Property Office (KIPO), the entire contents of which are hereby incorporated by reference.

### BACKGROUND

### 1. Technical Field

The present disclosure relates to a method and an apparatus for reconfiguring a microservice architecture, and more specifically, to a method and an apparatus for reconfiguring a microservice architecture that performs a mission by combining a plurality of tasks connected through signals.

### 2. Related Art

According to the prior arts, most application programs have been developed in a monolithic structure. The monolithic structure is based on a scheme of developing an application program as a unit of a large chunk, connecting various processes and databases necessary for operations of the application program, and organizing the application program hierarchically. In the monolithic structure, respective internal processes are closely linked to each other, and the application is usually developed using a single design program. On the other hand, in a microservice architecture, when developing an application program, the application program is divided into a plurality of small services, and the application program is constructed by merging the divided small services. That is, in the microservice architecture, one application service is created by specializing each service for each module and connecting and integrating the respective modules using interfaces.

When transmitting data collected from a sensor-attached Internet of Things (IoT) device to a cloud or server, the conventional device transmits data by implementing a program in form of firmware, or transmits data by using a program implemented using an embedded operating system (OS). In this case, since the conventional device implements an execution program suitable for a given purpose as firmware, there is a problem that it cannot support a scheme of changing a mission of the device or a service provided from the device to the server in runtime while the device is installed and operated.

In addition, in the case of transmitting data by using the program implemented using the embedded OS, in order to change the mission of transmitting the collected data from the device to the cloud or server, a program according to the changed mission should be downloaded again to the device and the data should be transmitted using the downloaded program. Therefore, the process of changing the mission by downloading the program according to the changed mission in the device involves a cumbersome process such as detaching and attaching the installed device, and there is a problem that the cost increases.

In addition, in case of a high-performance IoT device, an image including the changed program should be downloaded again through a network, and the changed program is operated by rebooting it. Alternatively, the changed program is delivered from the network to an OS capable of multiprocessing, the operation of the existing program is stopped, and the changed program is executed. However, this method has a problem in that it is difficult to upload sensing values to the cloud or server by using an OS in a small device due to insufficient memory capacity or CPU performance.

### SUMMARY

In order to solve the above-identified problems, exemplary embodiments of the present disclosure are directed to providing a microservice architecture reconfiguration method for supporting decomposition and recombination of tasks belonging to a microservice to provide various microservices in an IoT device.

In order to solve the above-identified problems, exemplary embodiments of the present disclosure are directed to efficiently providing users with a system service using an IoT device by facilitating decomposition and recombination of tasks.

According to an exemplary embodiment of the present disclosure for achieving the above-described objective, a method for reconfiguring a microservice architecture that performs a mission by combining a plurality of tasks connected through signals may comprise: decomposing a combination of tasks associated with a mission as the mission is changed; recombining tasks by varying the combination of the tasks according to connection management information; and performing a changed mission based on the recombined tasks.

The recombining of the tasks comprises: obtaining task recombination identifier(s) from a task recombination command; extracting required tasks from a task list based on the task recombination identifier(s); extracting path(s) connecting the extracted tasks from a path list; and connecting signals between the extracted tasks based on the extracted paths.

The microservice architecture may include event inputs, event outputs, and a plurality of logic tasks, and may further include parameters used to control the plurality of logic tasks.

The connection management information may include task information and path information.

The task information may include information on ON or OFF statuses of tasks.

The path information may include information on a path changed according to the statuses of the tasks.

According to another exemplary embodiment of the present disclosure for achieving the above-described objective, an apparatus for reconfiguring a microservice architecture that performs a mission by combining a plurality of tasks connected through signal may comprise a processor; and a memory storing at least one instruction executable by the processor, wherein when executed by the processor, the at least one instruction causes the processor to: decompose a combination of tasks associated with a mission as the mission is changed; recombine tasks by varying the combination of the tasks according to connection management information; and perform a changed mission based on the recombined tasks.

In the recombining of the tasks, the at least one instruction may further cause the processor to: obtain task recombination identifier(s) from a task recombination command; extract required tasks from a task list based on the task recombination identifier(s); extract path(s) connecting the extracted tasks from a path list; and connect signals between the extracted tasks based on the extracted paths.

The microservice architecture may include event inputs, event outputs, and a plurality of logic tasks, and may further include parameters used to control the plurality of logic tasks.

The connection management information may include task information and path information.

The task information may include information on ON or OFF statuses of tasks.

The path information may include information on a path changed according to the statuses of the tasks.

According to the exemplary embodiments of the present disclosure as described above, there is an advantage of providing a structure of tasks provided in runtime when executed tasks are reduced due to a change in a mission performed by an IoT device providing a microservice or a limitation of power use. According to the exemplary embodiments of the present disclosure as described above, there is an advantage of providing a structure of tasks provided in runtime when executed tasks are increased due to a change in the mission performed by the IoT device providing a microservice or a margin of power use.

### BRIEF DESCRIPTION OF DRAWINGS

FIG. 1 is an exemplary diagram of an Open Services Gateway Initiative (OSGI) framework structure.

FIG. 2 is an operational flowchart illustrating a method for reconfiguring a microservice architecture according to an exemplary embodiment of the present disclosure.

FIG. 3 is an exemplary diagram of a microservice architecture.

FIG. 4 is a first exemplary diagram of a process of decomposing and recombining tasks.

FIG. 5 is a second exemplary diagram of a process of decomposing and recombining tasks.

FIG. 6 is an operational flowchart illustrating a process of decomposing and recombining tasks according to an exemplary embodiment of the present disclosure.

FIG. 7 is an exemplary diagram of a task link structure, FIG. 8 is an exemplary diagram of a path connect link structure, and FIG. 9 is an exemplary diagram of a connect line structure.

FIG. 10 is a first exemplary diagram of a microservice configured with a plurality of tasks to provide one service, FIG. 11 is a second exemplary diagram of a microservice configured with a plurality of tasks to provide one service, and FIG. 12 is a third exemplary diagram of a microservice configured with a plurality of tasks to provide one service.

FIG. 13 is a block diagram of an apparatus for reconfiguring a microservice architecture according to an exemplary embodiment of the present disclosure.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

FIG. 1 is an exemplary diagram of an Open Services Gateway Initiative (OSGI) framework structure.

There is an OSGI framework in which programs capable of providing various services are uploaded to a JAVA virtual machine (VM) and connections between them are provided to overcome shortcomings, such as temporary interruption of services due to rebooting or re-execution of a changed program in general IoT devices. Here, the OSGI has a name originated from a JAVA language-based dynamic platform, which allows devices connected through a network can share various services. That is, the OSGI may be a framework that supports a dynamic component model that a general JAVA platform does not provide.

Referring to FIG. 1, the OSGI may operate on the basis of bundle modules. That is, the OSGI is a framework that supports a flexible lifecycle model that allows an application composed of one or more bundles to be dynamically installed, executed, updated, stopped, and removed on the framework.

Also, the OSGI is a dynamic module system for JAVA, which uses bytecodes and virtual machine technology to allow applications to be assembled from bundles on a JAVA platform that ensures code compatibility. Here, a bundle may mean a unit indicating a component or application that is small in size and can be reused.

Applications combined from multiple bundles can be distributed where the OSGI framework is installed. In addition, the combined applications can dynamically change a connection structure between the bundles without restarting the system. In addition, the OSGI uses a Service Oriented Architecture (SOA) so that the connection structure can be dynamically changed.

That is, the respective bundles and applications can register their services in a service registry provided by the OSGI and export services through the OSGI, and bundles whose services are to be used can be easily imported from the service repository, and connected and used without strong coupling between the different components. Accordingly, the OSGI is a framework executed on a JAVA VM (JVM), and a program developed by a user is executed in form of a bundle within the OSGI.

The OSGI framework provides an architecture that provides various services by using user-developed program bundles. However, since the OSGI framework should be started on a JVM, it is difficult to use it in a general embedded OS. Accordingly, exemplary embodiments of the present disclosure provide a microservice architecture capable of decomposing and recombining tasks (bundles) usable in an embedded OS, which provides functions similar to those of the OSGI framework performed on the JVM.

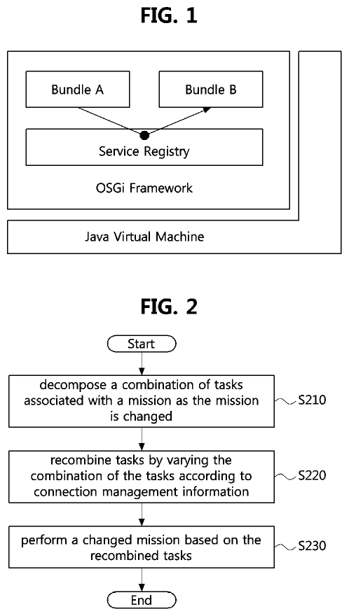

FIG. 2 is an operational flowchart illustrating a method for reconfiguring a microservice architecture according to an exemplary embodiment of the present disclosure.

Referring to FIG. 2, a method of reconfiguring a microservice architecture according to an exemplary embodiment of the present disclosure may be a method of reconfiguring a microservice architecture that performs a mission by combining a plurality of tasks connected through signals. It may include a step S210 of decomposing a combination of tasks associated with a mission as the mission is changed.

Here, the microservice architecture may include event inputs, event outputs, and a plurality of logic tasks, and may further include parameters used to control the plurality of logic tasks.

Further, the microservice architecture reconfiguration method according to an exemplary embodiment of the present disclosure may include a step S220 of recombining tasks by varying the combination of the tasks according to connection management information.

In this case, the step of recombining tasks by changing the combination of the tasks according to the connection management information may include: obtaining task recombination identifier(s) from a task recombination command; extracting required tasks from a task list based on the task recombination identifier(s); extracting path(s) connecting the extracted tasks from a path list; and connecting signals between the extracted tasks based on the extracted paths.

In addition, the connection management information may include task information and path information. Further, the task information may include information on an ON or OFF status of each task. Further, the path information may include information on a path that is changed according to the statuses of the tasks.

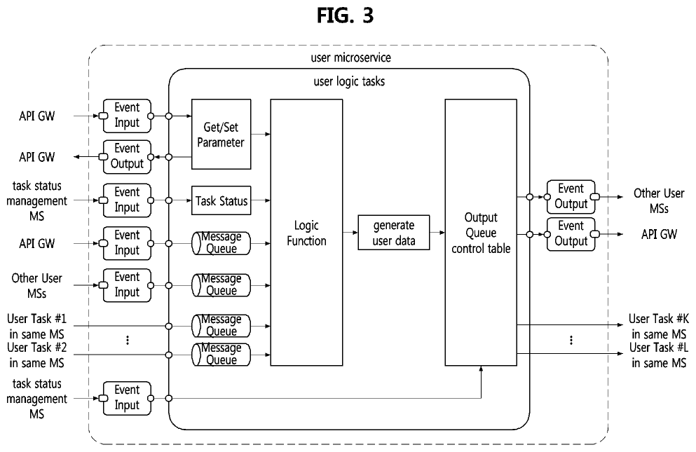

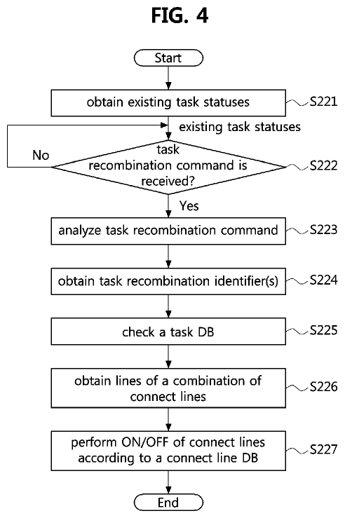

FIG. 3 is an exemplary diagram of a microservice architecture.

As described above, the microservice architecture may include event inputs, event outputs, and a plurality of logic tasks, and may further include parameters used to control the plurality of logic tasks. Further, referring to FIG. 3, a user microservice may be composed of a plurality of user logic tasks, and may manage connection paths between the tasks according to a mission. Here, the user's logic task may generate user data by performing a logic function based on input parameters, ON or OFF statuses of the tasks, and a queue that receives a user's command, and manage output information according to the given input.

FIG. 4 is an operational flowchart illustrating a process of decomposing and recombining tasks according to an exemplary embodiment of the present disclosure.

The microservice may manage task links, connection links, and connect line information for managing paths between tasks. In addition, in the microservice, task statuses may be changed according to a change in the mission, and connection paths may be changed according to the statuses of the tasks, so that the tasks may be decomposed and recombined.

Referring again to FIG. 2, the method of reconfiguring a microservice architecture according to an exemplary embodiment of the present disclosure, as a method of reconfiguring a microservice architecture that performs a mission by combining a plurality of tasks connected through signals, may include the step S210 of decomposing a combination of tasks associated with a mission as the mission is changed; a step S220 of recombining the tasks by varying the combination of the tasks according to connection management information; and a step S230 of performing the changed mission based on the recombined tasks (S230).

Here, the step S220 of recombining the tasks by varying the combination of the tasks according to the connection management information may include: obtaining task recombination identifier(s) from a task recombination command; extracting required tasks from a task list based on the task recombination identifier(s); extracting paths connecting the extracted tasks from a path list; and connecting signals between the extracted tasks based on the extracted paths.

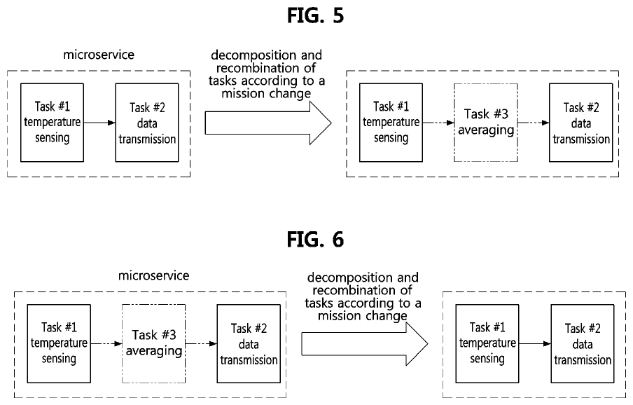

That is, referring to FIG. 5, in the case of decomposing and recombining tasks of a microservice according to an exemplary embodiment of the present disclosure, existing task statuses may be obtained (S221), and the task recombination command may be received (S222). When the task recombination command is received from the user, the task recombination command may be analyzed (S223). On the other hand, when the task recombination command is not received, the previous task statuses may be maintained.

In addition, according to the exemplary embodiment of the present disclosure, the task recombination command may be analyzed (S223) to obtain the task recombination identifier(s) (S224), and tasks required to perform the changed mission may be extracted from a task list based on the task recombination identifier(s). Here, the task list may refer to a list of tasks from management of the tasks, and may refer to a task database (DB).

In addition, according to the exemplary embodiment of the present disclosure, links of a combination of connect lines including paths connecting the tasks may be obtained from a path list by analyzing the extracted tasks (S226). Here, the path list may mean a list of paths representing connections between the tasks, and may mean a connect line database (DB).

Accordingly, according to the exemplary embodiment of the present disclosure, signals between the extracted tasks may be connected (S227) through the paths based on the links of the combination of connect lines extracted from the path list.

FIG. 5 is a first exemplary diagram of a process of decomposing and recombining tasks.

The present disclosure relates to a microservice architecture in which tasks are decomposed and recombined in runtime in order for a device belonging to a system providing a specific service in a cloud environment to provide the service to an edge or a cloud.

In addition, the decomposition and recombination of the tasks may occur when the mission is changed. For example, referring to FIGS. 5 and 6, when a mission, in which a temperature is sensed every second and transmitted to the cloud or edge, is assigned to an IoT device, if the mission is changed to a mission in which an average value of temperature values sensed for 10 seconds is taken and transmitted to reduce the battery consumption of the device, the decomposition and recombination of the tasks may occur.

That is, referring to FIGS. 5 and 6, when a microservice is composed of a task #1 that senses temperature and a task #2 that receives sensed data and transmits it to the cloud, the decomposition and recombination of the tasks may occur when the mission is changed. For example, if the mission is changed by adding a new task #3 that calculates an average value between the task #1 and task #2 to deliver the average temperature value to the system, since the sensed data output from the task #1 that was transferred to the task #2 should be transferred to the newly-created task #3, decomposition and recombination of the tasks may occur. Therefore, if the microservice wants to add the task #3 between the task #1 and the task #2 according to the given mission, it may decompose the tasks by disconnecting a signal connection between the task #1 and the task #2, connect the output of the task #1 to the input of task #3, and connect the output of the task #3 to the input of the task #2 to perform the changed mission.

Here, the microservice may structurally support a function for path change. That is, since the task can perform a function according to a given input and generate an output signal, and the output can be delivered by the microservice to the input of another task according to a given path, the microservice architecture should be designed in a structure in which the path can be changed according to the mission.

FIG. 6 is a second exemplary diagram of a process of decomposing and recombining tasks.

FIG. 6 shows a case opposite to that of FIG. 5, and when the microservice wants to exclude the task #3 according to a given mission, the mission may be changed by decomposing the tasks by disconnecting the signal connection between the task #1 and the task #3 and the signal connection between the task #3 and the task #2, and by connecting the output of the task #1 to the input of the task #2 and the output of the task #1 to the input of the task #2.

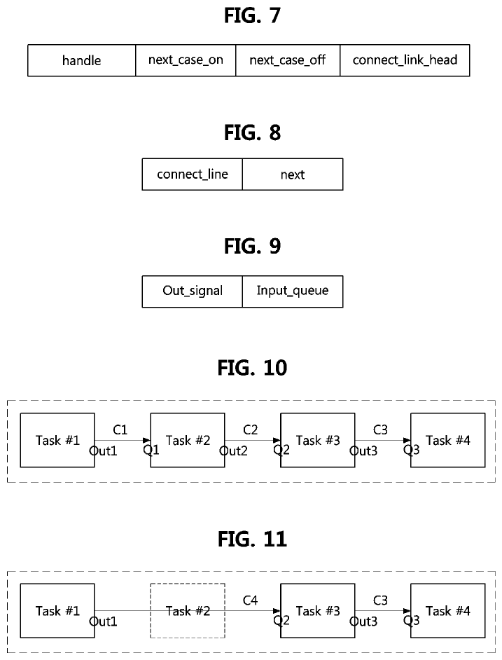

FIG. 7 is an exemplary diagram of a task link structure, FIG. 8 is an exemplary diagram of a path connect link structure, and FIG. 9 is an exemplary diagram of a connect line structure.

Referring back to FIG. 2, the method of reconfiguring a microservice architecture according to an exemplary embodiment of the present disclosure, as a method of reconfiguring a microservice architecture that performs a mission by combining a plurality of tasks connected through signals, may include the step S220 of recombining the tasks by varying the combination of the tasks according to the connection management information. In addition, the connection management information may include task information and path information.

In the microservice architecture, paths with which tasks are recombined may be changed according to ON or OFF statuses of the tasks in the microservice, and a path list according to the combination of statuses of the tasks may exist uniquely in the microservice.

Here, referring to FIG. 7, a task link structure related to a status of a task may include a ‘handle’ field for performing the task, a ‘next_case_on’ field for selecting a task to be performed when the status of the task is ON, a ‘next_case_off’ field for selecting a next task to be performed when the status of the task is OFF, and a ‘connect_link_head’ field for selecting a path list for a path connecting tasks within the combination of tasks in the microservice when there is no next task to be performed. That is, the task link structure, as the task information, may include information on the ON or OFF status of the task.

In addition, referring to FIG. 8, a path connect link structure may include a ‘connect line’ field including information on a path connection between a pair of tasks and a ‘next’ field for selecting a next task for which path connection is to be performed, based on the path list selected by the ‘connect_link_head’ field. That is, the path connection link structure, as the path information, may include information on a path that is changed according to the status of the task.

In addition, referring to FIG. 9, a connect line structure may include an ‘Out signal’ field for indicating an output signal and an ‘Input queue’ field for receiving an input signal, as a connect line for performing path connection between a pair of tasks, based on the information on path connection between a pair of tasks included in the field ‘connect line’ field.

That is, the connect line structure, as information on the connect lines connecting the tasks, may include an output signal according to the execution of the task. Also, the output signal may be transferred to another task as an input of another task according to a path.

Paths within the microservice may be activated or deactivated by changing the statuses of the tasks in the cloud. That is, the paths may be activated or deactivated by selecting a path list for paths connecting the combination of the tasks through the ‘connect_link_head’ field constituting a task link. Accordingly, by performing this process, the decomposition and recombination of tasks may occur in runtime as the statuses of the tasks in the microservice are changed in the cloud, and the paths may be changed.

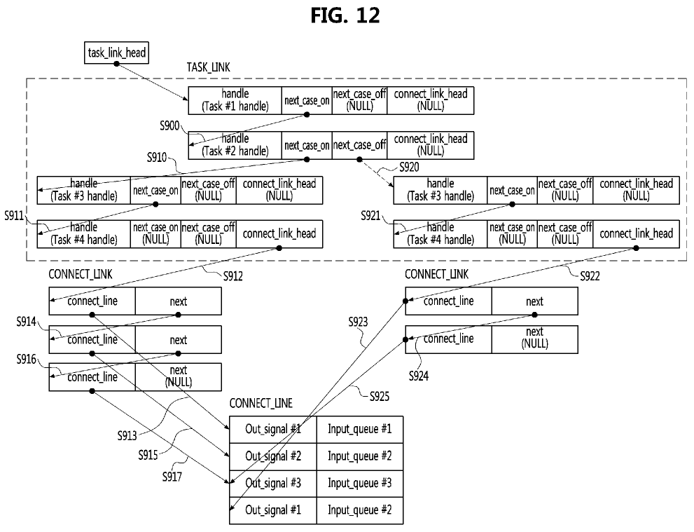

FIG. 10 is a first exemplary diagram of a microservice configured with a plurality of tasks to provide one service, FIG. 11 is a second exemplary diagram of a microservice configured with a plurality of tasks to provide one service, and FIG. 12 is a third exemplary diagram of a microservice configured with a plurality of tasks to provide one service.

Referring to FIGS. 10 and 11, one microservice is composed of four tasks. Here, the tasks of FIG. 10 are connected by connect lines C1, C2, and C3, respectively. In this case, when the microservice is to be provided while turning off the task #2, decomposition and recombination of the tasks may occur. That is, as shown in FIG. 11, the connect line C3 may be maintained, the connect lines C1 and C2 may disappear, and a connect line C4 may be created.

In order to perform change of the microservice in runtime as shown in FIGS. 10 and 11, referring to FIG. 12, signals between the tasks should be connected according to connection management information within the microservice. Accordingly, in the case of FIG. 10, since the statuses of all the tasks (i.e., tasks #1 to #4) in the microservice are ON, paths may be formed along S900 to S917, and signal connections between the tasks may be performed based on this. In addition, in the case of FIG. 11, since the statuses of the tasks #1 to #3 excluding the task #2 are ON in the microservice, paths may be formed along S900 to S925, and signal connections between the tasks may be performed based on this.

That is, referring again to FIG. 12, since the status of the task #1 is ON in both FIGS. 10 and 11, it is identical in that the task #2 is selected (S900) by the ‘next_case_on’ field in the task link structure. However, in the case of FIG. 10, since the status of the task #2 is ON, the task #3 is selected (S910) by the ‘next_case_on’ field in the task link structure, and thus signals between the task #1 and the task #2 are connected, and the signals between the task #2 and the task #3 are connected. On the other hand, in the case of FIG. 11, since the status of the task #2 is OFF, the task #3 is selected (S920) by the ‘next_case_off’ field in the task link structure, and thus signals between the task #1 and the task #2 are not connected, and the signals between the task #2 and the task #3 are not connected.

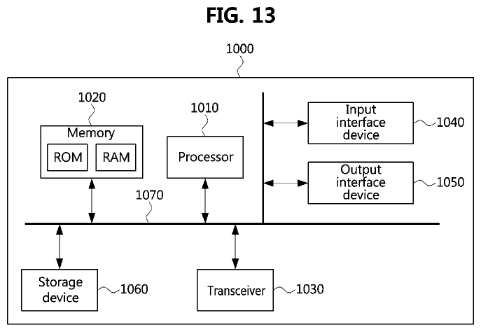

FIG. 13 is a block diagram of an apparatus for reconfiguring a microservice architecture according to an exemplary embodiment of the present disclosure.

Referring to FIG. 13, a microservice architecture reconfiguration apparatus 1000 according to an exemplary embodiment of the present disclosure may include a processor 1010, a memory 1020 storing at least one instruction executable by the processor 1010 and execution results of the at least one instruction, and a transceiver 1030 connected to a network to perform communication.

In addition, the microservice architecture reconfiguration apparatus 1000 may further include an input interface device 1040, an output interface device 1050, a storage device 1060, and the like. The components included in the distributed terminal 1000 may be connected by a bus 1070 to communicate with each other. However, each component included in the apparatus 1000 may be connected to the processor 1010 through a separate interface or a separate bus instead of the common bus 1070. For example, the processor 1010 may be connected to at least one of the memory 1020, the transceiver 1030, the input interface device 1040, the output interface device 1050, and the storage device 1060 through a dedicated interface.

The processor 1010 may execute at least one instruction stored in at least one of the memory 1020 and the storage device 1060. The processor 1010 may refer to a central processing unit (CPU), a graphics processing unit (GPU), or a dedicated processor on which the methods according to the exemplary embodiments of the present disclosure are performed. Each of the memory 1020 and the storage device 1060 may be configured as at least one of a volatile storage medium and a nonvolatile storage medium. For example, the memory 1020 may be configured with at least one of a read only memory (ROM) and a random access memory (RAM).

The storage device 1060 may further include a task list for managing tasks, a path link including paths for connecting the tasks, and connection management information.

Particularly, the at least one instruction may cause the processor to decompose a combination of tasks associated with a mission as the mission is changed; recombine tasks by varying the combination of the tasks according to connection management information; and perform a changed mission based on the recombined tasks.

Further, in the recombining of the tasks by varying the combination of the tasks according to connection management information, the at least one instruction may further cause the processor to obtain task recombination identifier(s) from a task recombination command; extract required tasks from a task list based on the task recombination identifier(s); extract path(s) connecting the extracted tasks from a path list; and connect signals between the extracted tasks based on the extracted paths.

In addition, the microservice architecture may include event inputs, event outputs, and a plurality of logic tasks, and may further include parameters used to control the plurality of logic tasks.

In addition, the connection management information may include task information and path information. In addition, the task information may include information on ON or OFF statuses of tasks. In addition, the path information may include information on a path changed according to the statuses of the tasks.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

Although the present disclosure has been described with reference to preferred embodiments, it will be apparent to those skilled in the art that the present disclosure may be variously changed and modified without departing from the spirit and scope of the invention defined in the following claims.

What is claimed is:

1. A method for reconfiguring a microservice architecture that performs a mission by combining a plurality of tasks connected through signals, the method comprising:
decomposing a combination of tasks associated with a mission as the mission is changed;
recombining tasks by varying the combination of the tasks according to connection management information; and
performing a changed mission based on the recombined tasks.

2. The method according to claim 1, wherein the recombining of the tasks comprises:
obtaining task recombination identifier(s) from a task recombination command;
extracting required tasks from a task list based on the task recombination identifier(s);
extracting path(s) connecting the extracted tasks from a path list; and
connecting signals between the extracted tasks based on the extracted paths.

3. The method according to claim 1, wherein the microservice architecture includes event inputs, event outputs, and a plurality of logic tasks, and further includes parameters used to control the plurality of logic tasks.

4. The method according to claim 1, wherein the connection management information includes task information and path information.

5. The method according to claim 4, wherein the task information includes information on ON or OFF statuses of tasks.

6. The method according to claim 4, wherein the path information includes information on a path changed according to the statuses of the tasks.

7. An apparatus for reconfiguring a microservice architecture that performs a mission by combining a plurality of tasks connected through signal, the apparatus comprising:
a processor; and
a memory storing at least one instruction executable by the processor,
wherein when executed by the processor, the at least one instruction causes the processor to:
decompose a combination of tasks associated with a mission as the mission is changed;
recombine tasks by varying the combination of the tasks according to connection management information; and
perform a changed mission based on the recombined tasks.

8. The apparatus according to claim 7, wherein in the recombining of the tasks, the at least one instruction further causes the processor to:
obtain task recombination identifier(s) from a task recombination command;
extract required tasks from a task list based on the task recombination identifier(s);
extract path(s) connecting the extracted tasks from a path list; and
connect signals between the extracted tasks based on the extracted paths.

9. The apparatus according to claim 7, wherein the microservice architecture includes event inputs, event outputs, and a plurality of logic tasks, and further includes parameters used to control the plurality of logic tasks.

10. The apparatus according to claim 7, wherein the connection management information includes task information and path information.

11. The apparatus according to claim 10, wherein the task information includes information on ON or OFF statuses of tasks.

12. The apparatus according to claim 10, wherein the path information includes information on a path changed according to the statuses of the tasks.
